(19) United States
(12) Patent Application Publication
(10) Pub. No.: US 2018/0348551 A1
(43) Pub. Date: Dec. 6, 2018

(54) DISPLAY SUBSTRATE AND MANUFACTURING METHOD THEREOF, DISPLAY APPARATUS AND DRIVING METHOD THEREOF

(71) Applicants: BOE TECHNOLOGY GROUP CO., LTD., Beijing (CN); BEIJING BOE DISPLAY TECHNOLOGY CO., LTD., Beijing (CN)

(72) Inventor: Mingchao Wang, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 15/573,894

(22) PCT Filed: Mar. 29, 2017
(86) PCT No.: PCT/CN2017/078559

§ 371 Date: Nov. 14, 2017

(30) Foreign Application Priority Data
Oct. 14, 2016 (CN) 201610898157.X

(51) Int. Cl. G02F 1/1334; G02F 1/1335; G02F 1/137; G02F 1/1343

(52) U.S. Cl. CPC G02F 1/1334; G02F 1/13439; G02F 1/137; G02F 1/133555

(57) ABSTRACT

A display substrate for a display device. The display substrate may comprise a plurality of pixel regions (100). Each of the pixel regions (100) may comprise a reflective film layer (3) on a base substrate (10), a transflective layer (1) at a distance from the reflective film layer (3), and a first spacer layer (2-1) between the reflective film layer (3) and the transflective layer (1). The first spacer layer (2-1) has two operation modes: a transmission mode and a reflection mode.

### CROSS-REFERENCE TO RELATED APPLICATIONS

This application claims the benefit of the filing date of Chinese Patent Application No. 201610898157.X filed on Oct. 14, 2016, the disclosure of which is hereby incorporated by reference.

### TECHNICAL FIELD

The present invention relates to a display technology, and more particularly, to a display substrate and a manufacturing method thereof, a display apparatus, and a driving method thereof.

### BACKGROUND

IMOD (Interferometer Modulator) display technology is a new reflective display technology. The main structure of traditional IMOD display device includes two parallel reflective surfaces spaced apart at a certain distance from each other. Lights reflected by the two reflecting surfaces interfere with each other. When the wavelength of the lights and the distance between the two reflective surfaces satisfy a specific condition, interference strengthens. Therefore, a color of the reflected light can be selected by changing the distance between the two surfaces.

At present, the IMOD adjusts the spacing between the two reflective surfaces mainly through a micro-electromechanical system (MEMS). The micro-electromechanical system mainly includes a variety of gears, springs, cantilevers, channels, and other small components. These small components make the structure of traditional IMOD display device very complex, and make the production process complicated. In addition, it is also difficult to use this tiny motor drive to move the substrate to an accurate position. These shortcomings prevent wide application of the IMOD technology.

### BRIEF SUMMARY

Accordingly, one example of the present disclosure is a display substrate. The display substrate may comprise a plurality of pixel regions. Each of the pixel regions may comprise a reflective film layer on a base substrate, a transflective layer at a distance from the reflective film layer, and a first spacer layer between the reflective film layer and the transflective layer. The transflective layer has a surface away from the base substrate. The first spacer layer has a surface facing the transflective layer. A first distance from the surface of the transflective layer to the surface of the first spacer layer may be k₁λ₁/2. A third distance from the surface of the transflective layer to the surface of the reflective film layer may be k₃λ₃/2. Each of 2₁and ₂₃ is a wavelength of a light of a color, and each of k₁ and k₃ is a positive integer.

The display substrate may further comprise a second spacer layer between the reflective film layer and the transflective layer. The second spacer layer has a surface facing the transflective layer. A second distance from the surface of the transflective layer to the surface of the second spacer layer may be k₂λ₂/2. λ₂ is a wavelength of a light of a color, and k₂ is a positive integer. The transflective layer may be substantially parallel with the reflective film layer, the first spacer layer, and the second spacer layer. In one embodiment, λ₁ is 450 nm, λ₂ is 520 nm, and λ₃ is 675 nm.

The transflective layer may be made of metal-induced polycrystalline silicon. The transflective layer is configured to transmit a portion of a light irradiating the surface of the transflective layer and reflects a portion of the light irradiating the surface of the transflective layer.

Each of the first spacer layer and the second spacer layer is configured to switch between two operation modes of a transmission mode and a reflection mode. When the first spacer layer or the second spacer layer is in the transmission mode, light transmittance of the corresponding first spacer layer or second spacer layer is greater than a first transmittance. When the first spacer layer or the second spacer layer is in the reflection mode, the light transmittance of the corresponding first spacer layer or second spacer layer is less than a second transmittance. In one embodiment, the first transmittance is approximately 90% and the second transmittance is approximately 10%.

The display substrate may further comprise a control unit. The control unit is configured to switch the transmission mode and the reflection mode. The control unit may comprise a first transparent electrode on the surface of the first spacer layer and a second transparent electrode on the other surface of the first spacer layer. The operation mode of the first spacer layer is configured to switch under a control of a voltage applied to the first transparent electrode and the second transparent electrode. The control unit may further comprise another first transparent electrode on the surface of the second spacer layer and another second transparent electrode on the other surface of the second spacer layer. The operation mode of the second spacer layer is configured to switch under a control of a voltage applied to the another first transparent electrode and the another second transparent electrode

In one embodiment, the first spacer layer and the second layer each is made of polymer dispersed liquid crystals. The polymer dispersed liquid crystals are made of liquid crystals and a first polymer. The first polymer may be an acrylate polymer or a carbonate polymer. The liquid crystals have good dispersion in the first polymer.

In another embodiment, the first spacer layer and the second spacer layer each is made of a photonic crystal material or a photorefractive crystalline material.

An insulating layer may be disposed between the transflective layer and the first spacer layer, or between the first spacer layer and the second spacer layer, or between the second spacer layer and the reflective optical layer. The insulating layer may be made of SiNₓ, SiOₓ, SiNₓO_{y}, or epoxy resin, etc.

The reflective film layer of each of the plurality of pixel regions may be a part of the same reflective film layer. The transflective layer of each of the plurality of pixel regions may be a part of the same transflective layer. All the pixel regions may have the same structure.

Another example of the present disclosure is a display apparatus comprising the display substrate according to one embodiment of the present disclosure.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a schematic structural view of a display substrate according to one embodiment of the present disclosure.

FIG. 2 shows a schematic structural view of a pixel region according to one embodiment of the present disclosure.

FIG. 3 shows a schematic structural view of a pixel region according to one embodiment of the present disclosure.

FIG. 4 shows a schematic structural view of a pixel region according to one embodiment of the present disclosure.

FIG. 5 shows a schematic diagram of switching operation modes of a spacer layer according to one embodiment of the present disclosure.

FIG. 6 shows operation of a pixel region according to one embodiment of the present disclosure.

FIG. 7 shows operation of a pixel region according to one embodiment of the present disclosure.

FIG. 8 shows a waveform diagram of a reflected light in a pixel region according to one embodiment of the present disclosure.

### DETAILED DESCRIPTION

The present disclosure is described with reference to embodiments of the disclosure. Throughout the description of the disclosure, reference is made to FIGS. 1-8. When referring to the figures, like structures and elements shown throughout are indicated with like reference numerals.

### Embodiment One

FIG. 1 shows a schematic structural view of a display substrate according to one embodiment of the present disclosure. As shown in FIG. 1, the display substrate includes an opaque defining layer 11 disposed on a base substrate 10 for defining a plurality of pixel regions 100. Each pixel region 100 selectively reflects one color of light, and multiple pixel regions 100 cooperate to realize a colored display.

In one embodiment, the display substrate includes a pixel region R that reflects red light, a pixel region G that reflects green light, and a pixel region B that reflects blue light. A colored display can be realized based on the three reflected primary colors R, G, and B.

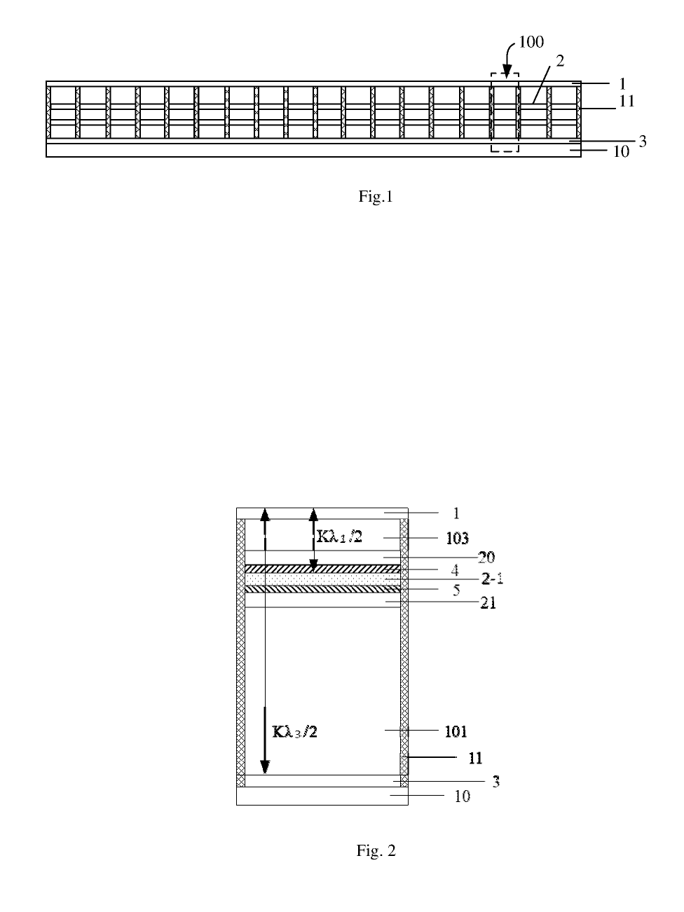

FIG. 2 shows a schematic structural view of a pixel region 100 according to one embodiment of the present disclosure. The pixel region 100 includes a reflective film layer 3 disposed on a base substrate 10, an transflective layer 1, and a first spacer layer 2-1 disposed between the reflective film layer 3 and the transflective layer 1. The transflective layer has a top surface away from the base substrate. The first spacer layer 2-1 has a top surface facing the transflective layer. A first distance from the top surface of the transflective layer to the top surface of the first spacer layer 2-1 is k₁λ₁/2. A third distance from the top surface of the transflective layer to the top surface of the reflective film layer is k₃λ₃/2. Each of λ₁ and λ₃ is a wavelength of a light of a color, and each of k₁ and k₃ is a positive integer. A distance between the two layers herein refers to a vertical distance between the two layers.

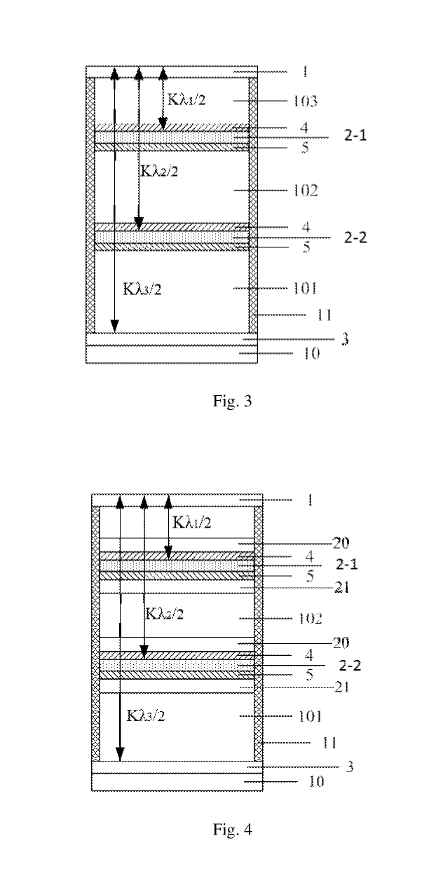

FIG. 3 shows a schematic structural view of a pixel region 100 according to one embodiment of the present disclosure. The pixel region 100 includes a reflective film layer 3 disposed on a base substrate 10, an transflective layer 1, and at least two spacer layers 2, a first spacer layer 2-1 and a second spacer layers 2-2, disposed between the reflective film layer 3 and the transflective layer 1. The transflective layer has a top surface away from the base substrate. Each of the first spacer layer 2-1 and the second spacer layers 2-2 has a top surface facing the transflective layer. A first distance from the top surface of the transflective layer to the top surface of the first spacer layer 2-1 is k₁λ₁/2. A second distance from the top surface of the transflective layer to the top surface of the second spacer layers 2-2 is k₂λ₂/2. A third distance from the top surface of the transflective layer to the top surface of the reflective film layer is k₃λ₃/2. Each of λ₁, λ₂, λ₃ is a wavelength of a light of a color, and each of k₁, k₂, and k₃ is a positive integer. A distance between the two layers herein refers to a vertical distance between the two layers.

When a light irradiates the top surface of the transflective layer 1, the transflective layer transmits a portion of the light and reflects a portion of the light, as shown in FIG. 6. Each of the spacer layers 2 has two operation modes: a transmission mode and a reflection mode. In the transmission mode, light transmittance of the spacer layer 2 is greater than a first transmittance. In the reflection mode, light transmittance of the corresponding spacer layer 2 is smaller than a second transmittance. In one embodiment, the first transmittance is approximately 90% and the second transmittance is approximately 10%.

The light transmittance of the spacer layer 2 in the transmission mode is preferably as large as possible, for example, greater than 70%, preferably greater than 90%. The light transmittance of the spacer layer 2 in the reflection mode state is preferably as small as possible, for example, less than 30%, preferably less than 10%.

The pixel region 100 may further comprise a control unit. The control unit is used for switching the operating modes of the spacer layer 2. In one embodiment, as shown in FIGS. 3-5, the control unit for switching the operating modes of the spacer layer 2 may comprise a first transparent electrode 4 and a second transparent electrode 5. The spacer layer 2 is disposed between the first transparent electrode 4 and the second transparent electrode 5. When a voltage is applied to the first transparent electrode 4 and the second transparent electrode 5, it is possible to switch the spacer layer 2 into a transmission mode. While no voltage is applied to the first transparent electrode 4 and the second transparent electrode 5, the spacer layer 2 is returned to the initial reflection mode.

In the present embodiment, a display substrate that realizes colored display based on light interference is provided. In order to utilize constructive interference to selectively reflect a color of a light by a pixel region, a first distance from the top surface of the transflective layer to the top surface of the first spacer layer 2-1 is k₁λ₁/2, a second distance from the top surface of the transflective layer to the top surface of the second spacer layers 2-2 is k₂λ₂/2, and a third distance from the top surface of the transflective layer to the top surface of the reflective film layer is k₃λ₃/2. Each of λ₁, λ₂, λ₃ is a wavelength of a light of a color, and each of k₁, k₂, and k₃ is a positive integer. That is, the lights that can interfere with each other in a pixel region are: the light reflected by the transflective layer 1 and the light reflected by one of a first spacer layer 2-1 and a second spacer layer 2-2, or the light reflected by the transflective layer 1 and the light reflected by the reflective film layer 3.

The operational principle of the display substrate is described in detail using the follow example in which a constructive interference occurs in a pixel region between the light reflected by a transflective layer 1 and the light reflected by a second spacer layer 2-2.

As shown in FIG. 6, when a light irradiates the transflective layer 1, a portion of the light is transmitted through the transflective layer 1, and a portion of the light is reflected back by the transflective layer 1 to form a reflected light by the transflective layer 1. The operation mode of the second spacer layers 2-2 is in a reflection mode. The operation modes of all the spacer layers including the first spacer layer 2-1 between the second spacer layers 2-2 and the transflective layer 1 are in a transmission mode. As such, the portion of light transmitted through the transflective layer 1 passes through the first spacer layer 2-1 and irradiates the second spacer layers 2-2. The second spacer layers 2-2 then reflects most of the irradiated light and forms a reflected light by the second spacer layers 2-2. Then, the reflected light by the second spacer layers 2-2 interferes with the light reflected by the transflective layer 1. Because the distance from the top surface of the transflective layer 1 to the top surface of the second spacer layers 2-2 is k₂λ₂/2, the optical path difference between the light reflected by the second spacer layer 2-2 (shown by the dash line 7 in FIG. 8) and the light reflected by the transflective layer 1 (shown by the dot-dash line 8 in FIG. 8) is k₂λ₂. Therefore, constructive interference occurs by the two reflected lights having the wavelength of λ₂ (the solid line 9 in FIG. 8 show the light after the constructive interference). Therefore, at a pixel region, the light reflected by the second spacer layer 2-2 and the light reflected by the transflective layer 1 can constructively interfere with each other, thereby selecting the color of the reflected light by the pixel region. The color of the reflected light by the pixel region depends on the transmittance of λ₂. In one embodiment, if λ₂ is 520 nm, the pixel region reflects a green light.

Similarly, if the first spacer layer 2-1 is in the reflection mode, a light transmitted through the transflective layer 1 irradiates the first spacer layer 2-1 and is reflected by the first spacer layer 2-1. Because the distance from the top surface of the transflective layer 1 to the top surface of the first spacer layer 2-1 is k₁λ₁/2, the optical path difference between the light reflected by the first spacer layer 2-1 and the light reflected by the transflective layer 1 is k₁λ₁. Therefore, constructive interference occurs by the two reflected lights having the wavelength of Therefore, at a pixel region, the light reflected by the first spacer layer 2-1 and the light reflected by the transflective layer 1 can constructively interfere with each other to select the color of the reflected light by the pixel region. The color of the reflected light by the pixel region depends on the transmittance of λ₁. In one embodiment, λ₁ is 450 nm, and the pixel region reflects a blue light.

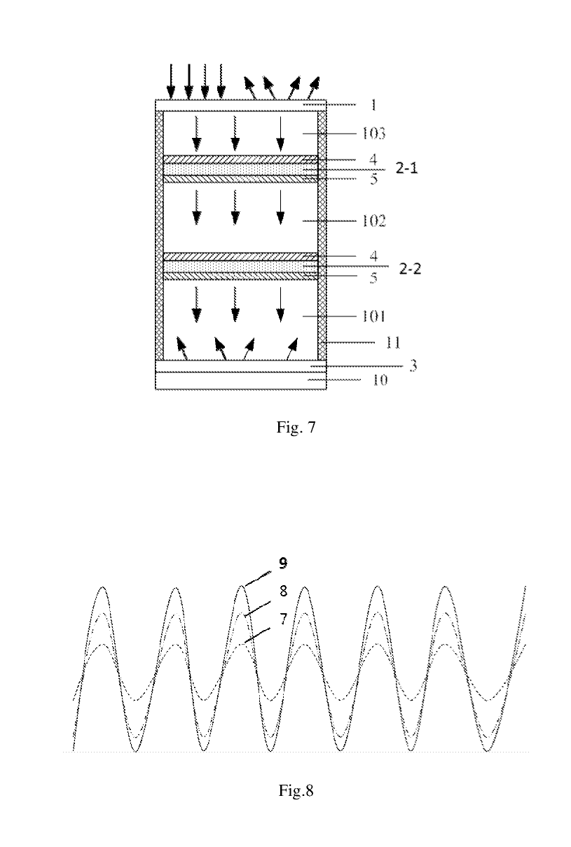

Similarly, as shown in FIG. 7, the light reflected by the reflective film layer 3 and the light reflected by the transflective layer 1 of a pixel region can constructively interfere with each other to select a color of the light reflected by the pixel region. All the spacer layers 2 located between the transflective layer 1 and the reflective film layer 3 are in a transmission mode, so that the light transmitted through the transflective layer 1 can irradiate the reflective film layer 3. Because the distance from the top surface of the transflective layer 1 to the top surface of the reflective film layer 3 is k₃λ₃/2, the optical path difference between the light reflected by the reflective film layer and the light reflected by the transflective layer 1 is k₃λ₃. Therefore, constructive interference occurs by the two reflected lights having the wavelength of λ₃. Therefore, at a pixel region, the light reflected by the reflective film layer 3 and the light reflected by the transflective layer 1 can constructively interfere with each other to select the color of the reflected light by the pixel region. The color of the reflected light by the pixel region depends on the transmittance of λ₃. In one embodiment, λ₃ is 675 nm, the pixel region reflects a red light.

In the above embodiment of the present disclosure , because only a spacer layer needs to be controlled in the reflection mode, and all of the other spacer layers located between the spacer layer and the transflective layer are controlled in a transmission mode, or all the spacer layers are controlled in the transmission mode so that the reflective film layer reflects the light, construction interference of lights having a particular color can be realized to select the color of the reflected light. There is no need to adjust positions of the transflective layer, the spacer layers or the reflective film layer, and their positions are fixed. As a result, this embodiment of the present disclosure has advantages such as simple structure, convenient manufacturing, high positioning accuracy, and good display quality.

The transflective layer 1 may be made of metal-induced polycrystalline silicon. A solution-metal-induced crystallization technique (S-MIC) has advantages such as its low cost and high quality. In the present embodiment, the metal-induced polycrystalline silicon may be prepared by a S-MIC method. Boron (B) may be doped in the preparation process to form a high quality metal-induced polycrystalline silicon thin film having a thickness of about 50 nm. An transflective layer 1 made of the metal-induced polycrystalline silicon film has characteristics of low absorption and nearly half-transmission and half-reflection in the visible light band. In one embodiment, the transflective layers 1 of all the pixel regions 100 have a unitary structure. That is, the transflective layers 1 of all the pixel regions 100 are parts of the same transflective, such as, the same metal-induced polycrystalline silicon thin film.

In order to simplify the structure and the fabrication process, the reflective film layers 3 of a plurality of pixel regions 100 may have a unitary structure and made from the same reflective film. The reflective film layer 3 may be an Ag metal film or a silver plated film prepared by an electroplating process or a magnetron sputtering process. In one embodiment, the reflective film layer 3 may be made of the same material as the spacer layer 2, and is controlled to operate only in the reflection mode by a control unit.

In another embodiment, as shown in FIG. 3, a transparent insulating layer may be provided between the transflective layer and the first spacer layer 2-1, between the two adjacent spacer layers 2, and between the second spacer layers 2-2 and the reflective film layer (for example, a first insulating layer 101, a second insulating layer 102, and a third insulating layer 103 respectively as illustrated in FIG. 3), so that the distances between the transflective layer 1, the two adjacent spacer layers 2, and the reflective film layer 3 can be adjusted to provide certain optical path difference to realize interference of lights having different colors.

The method of keeping adjacent two spacer layers 2 at a certain distance is not limited to the one described above. In one embodiment, as shown in FIG. 4, each of a first spacer layer 2-1 and a second spacer layer 2-2 may be provided between a first substrate 20 and a second substrate 21 of a cell. The first substrate 20 and the second substrate 21 are fixed to the defining layer 11 to ensure that a certain distance is provided between the adjacent two spacer layers 2. The first substrate 20 and the second substrate 21 may be a transparent glass substrate or a quartz substrate.

In one embodiment, to simplify the structure of the display substrate, all the pixel regions 100 can be provided with the same configuration, including the number of spacer layers 2 being the same; the distance from the transflective layer 1 to a spacer layer 2 adjacent to the transflective layer 1 being the same; the distance between the adjacent two spacer layers 2 being the same, and the distance from the reflective film layer 3 to a spacer layer 2 adjacent to the reflective film layer 3 being the same. For each pixel region 100, the distance from the top surface of the transflective layer 1 to the top surface of any of the spacer layers 2 may be an integral multiple of half the wavelength of light of a desired color for display. Furthermore, the distance from the top surface of the transflective layer 1 to the top surface of the reflective film layer 3 is also an integral multiple of half the wavelength of the light of the desired color for display. As such, each pixel region 100 can selectively reflect light of a desired color for display by controlling operation modes of the spacer layers 2.

In one embodiment, the display substrate includes a pixel region R that reflects red light, a pixel region G that reflects green light, and a pixel region B that reflects blue light. Specifically, as shown in FIG. 3, each pixel region comprises two spacer layers 2. The distance from the top surface of the transflective layer 1 to the top surface of one of the first spacer layers (closer to the transflective layer with respect to the other spacer layer) is set as Kλ_{Blue}/2. The distance from the top surface of the transflective layer to the top surface of the second spacer layer is set as Kλ_{Green}/2. The distance from the top surface of the transflective layer 1 to the top surface of the reflective film layer 3 is set as Kλ_{Red}/2. In this case, for a pixel region, when the first spacer layer 2 closer to the transflective layer is controlled to be in a reflection mode, the pixel region selectively reflects a blue light and accordingly exhibits blue color. When the second spacer layer 2 is controlled to be in the reflection mode, and the first spacer layers 2 closer to the transflective layer is in a transmission mode, the pixel region selectively reflects a green light and accordingly exhibits green color. When both the spacer layers 2 are controlled to be in a transmission mode, the reflective film layer 3 reflects the light, the pixel region selectively reflects a red light and accordingly exhibits red color. Since the structure of all the pixel regions can be set to be the same, the structure of the display substrate is very simple and the manufacturing process of the display substrate is simplified.

When the structure of all the pixel regions 100 of the display substrate is the same, because the distances from the transflective layer 1 to the reflective film layer 3 are the same, the transflective layers of all the pixel regions 100 may have an unitary structure, and are made of the same metal-induced polycrystalline silicon film, as shown in FIG. 1. Likewise, it is also possible to provide the reflective film layers 3 of all the pixel regions 100 as a unitary structure, and made of the same reflective film.

In another embodiment, when it is required that the light reflected by the reflective layer and the light reflected by the transflective layer constructively interfere to have different colors in different pixel regions, the transflective layers of all the pixel regions cannot be in an unitary structure. Then, the distance between the transflective layer and the reflective film layer may be designed in accordance with the color of the light to be selectively reflected, that is, the transflective layers of different pixel regions may be independent from each other.

There are many ways to realize the two operation modes of the spacer layer: reflection mode and transmission mode. Specifically, the operation mode of the spacer layer can be switched by a light control or an electrical control.

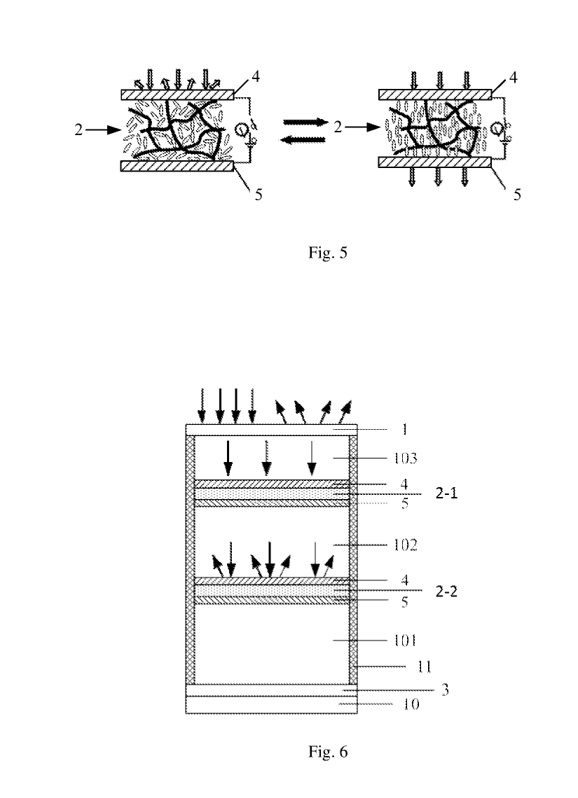

In one embodiment, as shown in FIG. 5, the spacer layer 2 is made of polymer dispersed liquid crystals. In polymer dispersed liquid crystals, small droplets of liquid crystals having sizes in the order of microns are dispersed in an organic solid polymer matrix. The optical axes of the small droplets constituted by liquid crystal molecules are in a disordered orientation, and the refractive index of the small droplets does not match with that of the matrix. When the light passing through the matrix is strongly scattered by the liquid crystal droplets, the spacer layer is opaque and realize a reflection mode. When an electric field is applied to the electrodes to adjust the orientation of the optical axes of the liquid crystal droplets, and the refractive index of the liquid crystal droplets is matched with that of the matrix, the spacer layer is transparent and realizes a transmission mode. When the electric field is removed, the liquid crystal droplets return to their initial disordered orientation.

The polymer dispersed liquid crystals can be made of a first polymer and liquid crystals. The first polymer can be an acrylate polymer. Due to its low viscosity, quick curing speed, good UV resistance, and strong adhesion to a transparent conductive layer, glass and plastic, the acrylate polymer can provide excellent comprehensive performance. The polymer dispersed liquid crystals made of an acrylate polymer and liquid crystals has advantages such as large contrast, low driving voltage, and the like.

It should be noted that the material for the spacer layer is not limited to a polymer dispersed liquid crystal layer. For example, a photonic crystal material or a photorefractive crystal material may be used, and the operation modes of the spacer layer can be switched by a light control. For example, for a photonic crystal material prepared by mixing a small amount (about 1%) of a photosensitive azo polymer (e.g. azobenzene) into liquid crystal molecules, the principle of switching the operation modes of the spacer layer by a light control is illustrated as follows: when the azo polymer is irradiated with linearly polarized ultraviolet light (wavelength: 366 nm), the azo polymer performs a reversible cis-trans isomerization. That is, the curved cis structure is transformed into a rod-like trans structure, thereby driving orientation of the liquid crystal molecules perpendicular to the polarization direction of the light. As such, the spacer layer is in transmission mode. When the azo polymer is irradiated with visible light (wavelength>400 nm), the structure of the azo polymer changes from trans to cis, and the liquid crystal molecules return to a disordered state, and the spacer layer is in a reflection mode.

In one embodiment, as shown in FIGS. 1-3 and 4, a display substrate includes a pixel region R that reflects red light, a pixel region G that reflects green light, and a pixel region B that reflects blue light. The display substrate includes an opaque defining layer 11 provided on the reflective film layer 3 for defining a plurality of pixel regions 100. The reflective film layer 3 has a silver-coating top surface facing the transflective layer. The reflective film layers of all the pixel regions 100 may have a unitary structure, that is, they are parts of the same layer. In one embodiment, as shown in FIG. 2, each pixel region 100 comprises a first insulating layer 101 and a third insulating layer 103 which are disposed on the reflective film layer 3 in this order. An acrylate polymer dispersed liquid crystal layer 2 is used as a spacer layer. The spacer layers is disposed between the first insulating layer 101 and the third insulating layer 103. A first transparent electrode 4 is disposed on and in contact with one side of the spacer layer 2. A second transparent electrode 5 is disposed on and in contact with the other side of the spacer layer 2. A transflective layer 1 is disposed on the third insulating layer 103. The distance from the top surface of the transflective layer 1 to the top surface of the spacer layer 2 is Kλ_{blue}/2. The distance from the top surface of the transflective layer 1 to the top surface of the reflective film layer 3 is Kλ_{red}/2. Specifically, λ_{blue}=450 nm, and λ_{red}=675 nm. The display substrate according to this embodiment can achieve a two-color display, and may be used in applications such as road signs or the like.

In another embodiment, as shown in FIG. 3, each pixel region 100 comprises a first insulating layer 101, a second insulating layer 102, and a third insulating layer 103 which are disposed on the reflective film layer 3 in this order. Two acrylate polymer dispersed liquid crystal layers 2 are used as spacer layers. One of the spacer layers is disposed between the first insulating layer 101 and the second insulating layer 102. The other spacer layer 2 is disposed between the second insulating layer 102 and the third insulating layer 103. A first transparent electrode 4 is disposed on and in contact with one side of each of the spacer layers 2. A second transparent electrode 5 is disposed on and in contact with the other side of each of the spacer layers 2. A transflective and semi-reflective transflective layer 1 is disposed on the third insulating layer 103. The distance from the top surface of the transflective layer 1 to the top surface of one of the spacer layers 2 (closer to the transflective layer 1 with respect to the other acrylate polymer dispersed liquid crystal layer) is Kλ_{blue}/2. The distance from the top surface of the transflective layer 1 to the top surface of the other spacer layer 2 is Kλ_{green}/2. The distance from the top surface of the transflective layer 1 to the top surface of the reflective film layer 3 is Kλ_{red}/2. Specifically, λ_{blue}=450 nm, λ_{green}=520 nm, and λ_{red}=675 nm.

It is to be noted that the above is only one specific example of the display substrate of the present disclosure, and the above-mentioned structure can be adjusted accordingly if necessary, and all of them are within the scope of the present disclosure.

In another embodiment, there is also provided a method of manufacturing a display substrate. The method includes forming an opaque defining layer on a base substrate for defining a plurality of pixel regions and forming the pixel regions. The step of forming each of the pixel regions includes forming a reflective film layer on the base substrate, forming an transflective layer at a distance from the reflective layer. The transflective layer has a top surface opposite to the reflective film layer. The transflective layer is used for transmitting and reflecting a portion of the light irradiating the top surface thereof.

The step of forming each of the pixel regions further includes forming at least two spacer layers between the reflective film layer and the transflective layer. The spacer layers have two operating modes: a transmission mode and a reflection mode. Light transmittance of the spacer layer is greater than a first transmittance in the transmission mode. Light transmittance of the spacer layer is less than a second transmittance in the reflection mode. Each of the distances from the top surface of the transflective layer to the top surfaces of the spacer layers or the top surface of the reflective film layer in a direction perpendicular to a plane in which the base substrate is located satisfies a relationship of Kλ/2. λ is a wavelength of the light reflected by the corresponding pixel region, and K is a positive integer.

The step of forming each of the pixel regions further includes forming a control unit for switching the operation modes of the spacer layers. In one embodiment, the spacer layer may be made of polymer dispersed liquid crystals. The spacer layer may be made by the following method: first, a first polymer is prepared. Then, the first polymer and the liquid crystals are uniformly mixed in a certain volume ratio to form a composite material. Then, a first film is formed from the composite material, and cured to form the spacer layer. The liquid crystals are disorderly distributed in the spacer layer so that the initial operation mode of the spacer layer is a reflection mode.

In one embodiment, the step of forming the spacer layer using an acrylate polymer as the first polymer is exemplified as follows:

First, a monomer (e.g., tripropylene glycol diacrylate), an oligomer (e.g., a urethane acrylate), and a photoinitiator (e.g., IRGACURE® 184) are mixed according to a certain ratio to form an acrylate polymer. Then, the acrylate polymer and liquid crystals are uniformly mixed in a volume ratio of 1:1 to form a composite material. Then, a first thin film is formed on a transparent electrode using the composite material. Finally, the first thin film is cured with ultraviolet light having a wavelength of 365 nm in a room temperature to form a polymer dispersed liquid crystal layer, and a spacer layer is formed from the polymer dispersed liquid crystal layer.

When an electric field is applied to the spacer layer produced by the above method through the transparent electrodes, the operation mode of the spacer layer can be switched to a transmission mode by an electrical control. When the electric field is removed, the spacer layer returns to the initial reflection mode.

### Embodiment Two

Another example of the present disclosure is a display device including the display substrate in accordance with one embodiment of the present disclosure. The display device can utilize constructive interference to selectively reflect lights of a certain color to achieve colored display, without the need of adjusting the positions of the reflective structure. Due to the fixed position of the reflective structure, the display device has advantages such as simple structure, ease to manufacture, high positioning accuracy, and good display quality.

Another example of the present disclosure is a driving method of the display device as described above. The display device includes a plurality of pixel regions reflecting lights of a specific color. In one embodiment, the driving method comprises, for a pixel region, an operating mode of one of at least two spacer layers is controlled to be in a reflection mode. The operation modes of all the spacer layers between the spacer layer which is in the reflection mode and the transflective layer are controlled to be in a transmission mode. In a direction perpendicular to the plane of the base substrate, the distance from the top surface adjacent to the display side of the transflective layer to the top surface adjacent to the display side of the spacer layer which is in the reflection mode is Kλ/2.

In another embodiment, operating modes of all the spacer layers between the reflective film layer and the transflective layer are controlled to be in a transmission mode. In a direction perpendicular to the plane in which the base substrate is located, the distance from the top surface adjacent to the display side of the transflective layer to the top surface adjacent to the display side of the reflective film layer is Kλ/2, where K is a positive integer and λ is the wavelength of the reflected light in the corresponding pixel region.

In the above driving method, a spacer layer is controlled to be in a reflection mode, and all the other spacer layers between the spacer layer in the reflection mode and the transflective layer are controlled to be in a transmission mode. Alternatively, all the spacer layers are controlled to be in a transmission mode so that the reflective film layer reflects light. As such, constructive interference of lights having a specific color can be realized to select the color of the reflected light. The positions of the spacer layer and the reflective film layer need not be adjusted, and their positions are fixed. The present disclosure has advantages such as simple structure, easy to manufacture, high positioning precision, and good display quality.

The reflective film layer may also be made of the same material as the spacer layer, and the drive method may further comprise controlling the operation mode of the reflective film layer to be a reflection mode.

In the present embodiment, the spacer layer may be made of polymer dispersed liquid crystals. The initial operation mode of the spacer layer is a reflection mode. The operating mode of the spacer layer can be switched to a transmission mode by an electrical control. Specifically, when an electric field is applied to the spacer layer, the operating mode of the spacer layer is controlled to be a transmission mode. After removal of the electric field, the spacer layer again returns to its initial transmission mode.

When the spacer layer is made of a photonic crystal material or a photorefractive crystalline material, the operation mode of the spacer layer can be switched by a light control. For example, a spacer layer made of a photonic crystal material prepared by mixing a small amount (about 1%) of a photosensitive azo polymer (e.g., azobenzene) into liquid crystal molecules is irradiated with linearly polarized ultraviolet light (wavelength: 366 nm), the azo polymer exhibits reversible cis-trans isomerization. The curved cis structure is converted into a rod-like trans structure, which drives the liquid crystal molecules to be oriented perpendicularly to the polarization direction of the light. As a result, the spacer layer is in a transmission mode. When the spacer layer is irradiated with visible light (wavelength>400 nm), the structure of the azo polymer is converted from trans-form to cis-form, the liquid crystal molecules return to a disordered state and the spacer layer is in a reflection mode.

In one embodiment, the display device includes a pixel region R that reflects red light, a pixel region G that reflects green light, and a pixel region B that reflects blue light. Each pixel region comprises two spacer layers, the spacer layer being fabricated from polymer dispersed liquid crystals. The driving method of the display device in this embodiment includes, for the pixel region B, a spacer layer adjacent to the transflective layer is controlled to be in a reflection mode. Specifically, an electric field is not applied to the spacer layer, and the distance from the top surface adjacent to the display side of the transflective layer to the top surface adjacent to the display side of the spacer layer is Kλ_{blue}/2. When a light irradiates the transflective layer, a portion of the light is reflected, and a portion of the light is transmitted through the transflective layer to irradiate the spacer layer. The spacer layer reflects the light, and the blue light reflected by the transflective layer and the blue light reflected by the spacer layer constructively interfere with each other. As a result, the pixel region reflects a blue light and exhibits a blue color.

For the pixel region G, a spacer layer adjacent to the transflective layer is controlled in a transmission mode (specifically, an electric field is applied to the spacer layer), and the other spacer layer away from the transflective layer is in a reflection state. The distance from the top surface adjacent to the display side of the transflective layer to the top surface adjacent to the display side of the other spacer layer is Kλ_{green}/2. When a light irradiates the transflective layer, a portion of the light is reflected, and a portion of the light is transmitted through the transflective layer to irradiate the other spacer layer, and the other spacer layer reflects light. The green light reflected by the transflective layer and the green light reflected by the other spacer layer constructively interfere with each other so that the pixel region reflects a green light and exhibits a green color.

For the pixel region R, both of the spacer layers are controlled to be in a transmission mode. Specifically, an electric field is applied to the two spacer layers, and the distance between the top surface adjacent to the display side of the transflective layer and the top surface adjacent to the display side of the reflective film layer is Kλ_{red}/2. When a light irradiates the transflective layer, a portion of the light is reflected, and a portion of the light is transmitted through the transflective layer and the reflective film layer reflects the light. The red light reflected by the transflective layer and the red light reflected by the reflective film layer constructively interfere with each other so that the pixel region reflects a red light and exhibits a red color.

While the foregoing is merely a preferred embodiment of the present disclosure, it should be noted that modifications and substitutions may be made by those skilled in the art without departing from the principles of the present disclosure. It should be understood that the present disclosure is not limited thereto.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A display substrate comprising:
a plurality of pixel regions, each of the pixel regions comprising:
a reflective film layer on a base substrate;
a transflective layer at a distance from the reflective film layer, the transflective layer having a surface away from the base substrate; and
a first spacer layer between the reflective film layer and the transflective layer, the first spacer layer having a surface facing the transflective layer;
wherein a first distance from the surface of the transflective layer to the surface of the first spacer layer is k₁λ/2 and a third distance from the surface of the transflective layer to the surface of the reflective film layer is k₃λ₃/2, wherein each of λ₁ and λ₃ is a wavelength of a light of a color, and each of k₁ and k₃ is a positive integer.

2. The display substrate of claim 1, further comprising a second spacer layer between the reflective film layer and the transflective layer, the second spacer layer having a surface facing the transflective layer;
wherein a second distance from the surface of the transflective layer to the surface of the second spacer layer is k₂λ₂/2, λ₂ is a wavelength of a light of a color, and k₂ is a positive integer.

3. The display substrate of claim 2, wherein λ₁ is 450 nm, λ₂ is 520 nm, and λ₃ is 675 nm.

4. The display substrate of claim 1, wherein the transflective layer is made of metal-induced polycrystalline silicon.

5. The display substrate of claim 1, wherein the transflective layer is configured to transmit a portion of a light irradiating the top surface of the transflective layer and reflects a portion of the light irradiating the top surface of the transflective layer.

6. The display substrate of claim 2, wherein each of the first spacer layer and the second spacer layer is configured to switch between two operation modes of a transmission mode and a reflection mode.

7. The display substrate of claim 6, wherein when the first spacer layer or the second spacer layer is in the transmission mode, light transmittance of the corresponding first spacer layer or second spacer layer is greater than a first transmittance; and when the first spacer layer or the second spacer layer is in the reflection mode, the light transmittance of the corresponding first spacer layer or second spacer layer is less than a second transmittance.

8. The display substrate of claim 7, wherein the first transmittance is approximately 90% and the second transmittance is approximately 10%.

9. The display substrate of claim 6, the display substrate further comprising a control unit,
wherein the control unit is configured to switch the transmission mode and the reflection mode.

10. The display substrate of claim 9, wherein the control unit comprises a first transparent electrode on the surface of the first spacer layer and a second transparent electrode on the other surface of the first spacer layer, and the operation mode of the first spacer layer is configured to switch under a control of a voltage applied to the first transparent electrode and the second transparent electrode.

11. The display substrate of claim 10, wherein the control unit further comprises another first transparent electrode on the surface of the second spacer layer and another second transparent electrode on the other surface of the second spacer layer, and the operation mode of the second spacer layer is configured to switch under a control of a voltage applied to the another first transparent electrode and the another second transparent electrode.

12. The display substrate of claim 2, wherein each of the first spacer layer and the second spacer layer is made of polymer dispersed liquid crystals.

13. The display substrate of claim 12, wherein the polymer dispersed liquid crystals are made of liquid crystals and a first polymer.

14. The display substrate of claim 13, wherein the first polymer is an acrylate polymer.

15. The display substrate of claim 2, wherein the first spacer layer and the second spacer layer each is made of a photonic crystal material or a photorefractive crystalline material.

16. The display substrate of claim 2, wherein an insulating layer is disposed between the transflective layer and the first spacer layer, or between the first spacer layer and the second spacer layer, or between the second spacer layer and the reflective optical layer.

17. The display substrate of claim 1, wherein the reflective film layer of each of the plurality of pixel regions is a part of the same reflective film layer.

18. The display substrate of claim 1, wherein the transflective layer of each of the plurality of pixel regions is a part of the same transflective layer.

19. The display substrate of claim 1, wherein all the pixel regions have the same structure.

20. A display apparatus comprising the display substrate according to claim 1.
